(19) United States
(12) Patent Application Publication
(10) Pub. No.: US 2018/0050667 A1
(43) Pub. Date: Feb. 22, 2018

(54) PORTABLE VEHICLE WASH CONTAINER

(71) Applicant: Zakir Hossain, Warren, MI (US)

(72) Inventor: Zakir Hossain, Warren, MI (US)

(21) Appl. No.: 15/239,449

(22) Filed: Aug. 17, 2016

(51) Int. Cl. B60S 3/04; B08B 3/02

(52) U.S. Cl. CPC B60S 3/04; B08B 3/026

(57) ABSTRACT

A portable vehicle wash container for enabling a user to wash a vehicle comprises at least two ramps, a clean fluid reservoir (CFR), a waste fluid reservoir (WFR), and a power generator. The ramps are detachably attached to an entrance and an exit of a container for facilitating an entry and an exit of the vehicle. The CFR comprises a pressure hose (PH) for supplying a fluid. The WFR comprises a vacuum hose in fluid communication with a waste receptacle for transferring the waste fluid to the WFR. The waste receptacle is positioned beneath the vehicle to receive waste fluid. The power generator powers the PH and the vacuum hose. The container comprises a space for receiving the vehicle. The CFR, the WFR, and the power generator are positioned in the space. The user washes the vehicle in the space of the container using clean fluid from the PH.

### TECHNICAL FIELD OF THE INVENTION

The invention disclosed herein generally relates to mobile vehicle washing units. More particularly, the invention disclosed herein relates to shipping containers converted to a portable vehicle wash container.

### BACKGROUND OF THE INVENTION

Automobile washing facilities are typically facilities used to clean the exterior of vehicles. In some cleaning facilities, interior cleaning options are also available. With the increasing use of vehicles, for example, cars, sport utility vehicles (SUVs), etc., for transit within cities, the exteriors and interiors of such vehicles are prone to dust and dirt. If left unattended for prolonged periods, the coating of dirt on the exterior of the vehicle increases the chances of rust. Existing portable cleaning facilities are essentially cleaning units mounted on trucks or other large vehicles. These units complete multiple rounds around locations, for example, parking lots, etc. This increases the carbon emissions and is not therefore eco-friendly. A vehicle wash device, which is portable and does not negatively affect the environment, is required.

Traditionally, existing mobile cleaning units are capable of handling only small vehicles. Furthermore, existing mobile cleaning units are hidden within the body of the truck or trailer used to haul the unit. This reduces visibility of the unit and the features it offers. A vehicle wash device, which is capable of accommodating large and small vehicles alike and is visible to the public, is required. Conventionally, mobile cleaning units use mechanical equipment, for example, sprinklers, jets, etc., for cleaning purposes. This reduces the control of the user in optimally utilizing available water without unnecessary wastage. A vehicle wash device, which uses minimal water for cleaning vehicles, is required.

Hence, there is a long felt but unresolved need for a vehicle wash device, which is portable and does not negatively affect the environment. Furthermore, there is a need for a vehicle wash device, which is capable of accommodating large and small vehicles alike and is visible to the public. Moreover, there is a need for a vehicle wash device, which uses minimal water for cleaning vehicles.

### SUMMARY OF THE INVENTION

This summary is provided to introduce a selection of concepts in a simplified form that are further disclosed in the detailed description of the invention. This summary is not intended to identify key or essential inventive concepts of the claimed subject matter, nor is it intended for determining the scope of the claimed subject matter.

The invention disclosed herein addresses the above-mentioned need for vehicle wash device, which is portable and does not negatively affect the environment. Furthermore, the invention addresses a need for a vehicle wash device, which is capable of accommodating large and small vehicles alike and is visible to the public. Moreover, the invention addresses a need for a vehicle wash device, which uses minimal water for cleaning vehicles. The portable vehicle wash container for enabling a user to wash a vehicle comprises at least two ramps, a clean fluid reservoir, a waste fluid reservoir, and a power generator. The ramps are detachably attached to an entrance and an exit of a container for facilitating an entry and an exit of the vehicle. The clean fluid reservoir comprises a pressure hose for supplying a fluid. The waste fluid reservoir comprises a vacuum hose in fluid communication with a waste receptacle for transferring the waste fluid to the waste fluid reservoir. The waste receptacle is positioned beneath the vehicle to receive waste fluid. The power generator powers the pressure hose and the vacuum hose. The container comprises a space for receiving the vehicle. The clean fluid reservoir, the waste fluid reservoir, and the power generator are positioned in the space. The user washes the vehicle in the space of the container using clean fluid from the pressure hose.

### BRIEF DESCRIPTION OF THE DRAWINGS

The foregoing summary, as well as the following detailed description of the invention, is better understood when read in conjunction with the appended drawings. For the purpose of illustrating the invention, exemplary constructions of the invention are shown in the drawings. However, the invention is not limited to the specific methods and structures disclosed herein. The description of a method step or a structure referenced by a numeral in a drawing is applicable to the description of that method step or structure shown by that same numeral in any subsequent drawing herein.

FIG. 1 exemplarily illustrates a front elevation view of a portable vehicle wash container.

FIG. 2 exemplarily illustrates a front elevation view of a portable vehicle wash container.

### DESCRIPTION OF THE PREFERRED EMBODIMENT

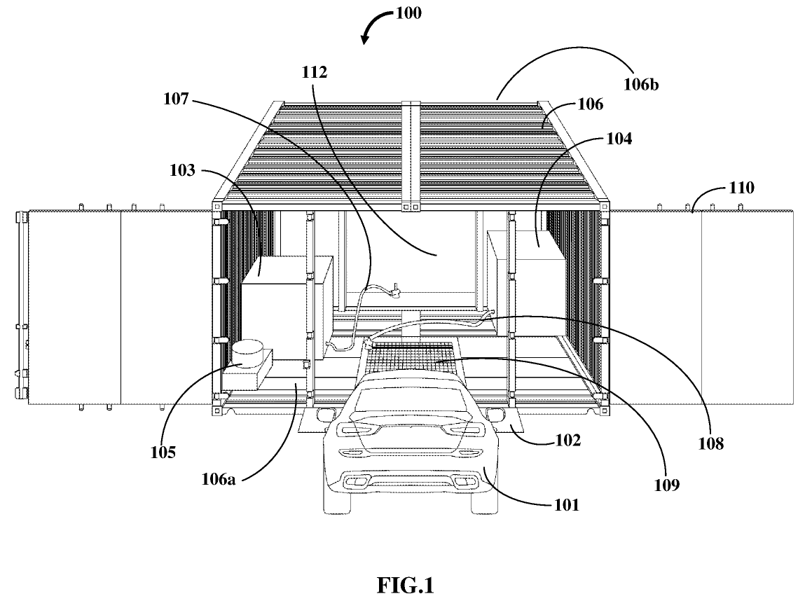

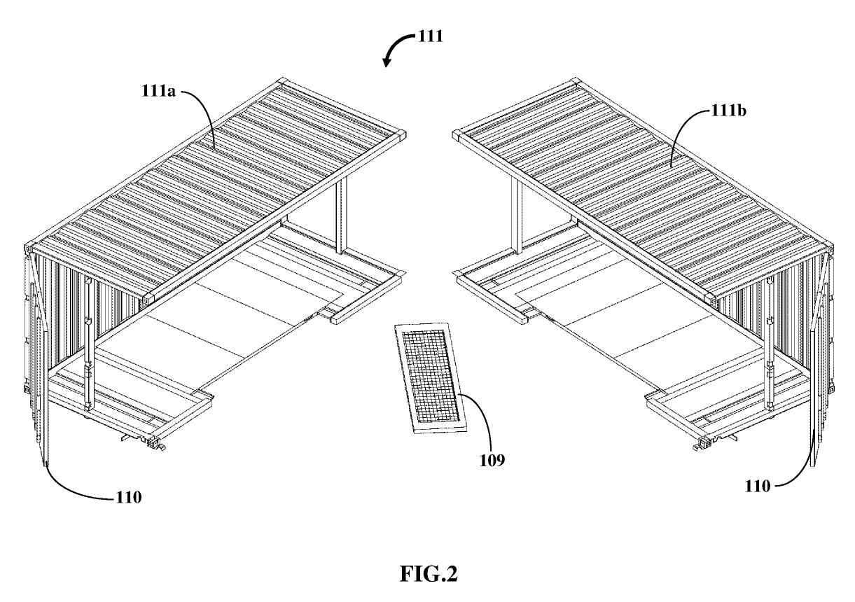

FIG. 1 exemplarily illustrates a front elevation view of a portable vehicle wash container 100. FIG. 2 exemplarily illustrates a front perspective view of a portable vehicle wash container 100. The portable vehicle wash container 100 for enabling a user to wash a vehicle 101 comprises at least two ramps 102, a clean fluid reservoir 103, a waste fluid reservoir 104, a power generator 105, and a container 106. The ramps 102 are detachably attached to an entrance 106a and an exit 106b of the container 106 for facilitating an entry and an exit of the vehicle 101. In an embodiment, the vehicle 101 is, for example, a car, a jeep, a minivan, a pickup truck, etc. The clean fluid reservoir 103 comprises a pressure hose 107 for supplying a clean fluid to wash the vehicle 101. The waste fluid reservoir 104 comprises a vacuum hose 108. In an embodiment, the vacuum hose 108 is in fluid communication with a waste receptacle 109 for transferring the waste fluid from the waste receptacle 109 to the waste fluid reservoir 104. In an embodiment, the waste receptacle 109 is positioned beneath the vehicle 101 to receive waste fluid from washing the vehicle 101. The power generator 105 powers the pressure hose 107 and the vacuum hose 108.

In an embodiment, the portable vehicle wash container 100 comprises portals 110 hingedly attached to opposing ends 106a and 106b of the container 106 for controlling the entry or the exit of the vehicle 101. In an embodiment, the container 106 is a modified shipping container 111 as exemplarily illustrated in FIG. 2. In an embodiment, the modified shipping container 111 has a generally hollow cuboidal configuration comprising a space 112 for receiving the vehicle 101. The modified shipping container 111 comprises at least two shipping containers 111a and 111b positioned adjacent to each other. An adjacent sidewall of each of the two shipping containers 111a and 111b are removed for fixedly attaching the two shipping containers 111a and 111b to form the modified shipping container 111. The user washes the vehicle 101 in the space 112 of the modified shipping container 111 as exemplarily illustrated in FIGS. 1-2. The clean fluid reservoir 103, the waste fluid reservoir 104, and the power generator 105 are positioned in the space 112. The user washes the vehicle 101 in the space 112 of the modified shipping container 111 using clean fluid from the pressure hose 107.

The portable vehicle wash container 100 only requires a mobile apparatus to transport the portable vehicle wash container 100 to the location. After completion of the operation, the portable vehicle wash container 100 is picked up requiring no parking lot rounds. This reduces the carbon emissions to the environment making the portable vehicle wash container 100 eco-friendly. Since the modified shipping container 111 uses two shipping containers 111a and 111b and combines both, this allows ample space for workers and larger vehicles to fit comfortably since the modified shipping container 111 is wider. In an embodiment, the modified container 111 is bright and visible, not hidden within a truck. The modified shipping container 111 is transported to a location. Individuals then drop their vehicle 101 off and come back later to receive the clean hand washed vehicle 101 parked and ready for the user. When the day ends the modified shipping container 111 is picked up. Since there is no truck attachment present, the portable vehicle wash container 100 fits in more places. The portable vehicle wash container 100 uses manual labor to wash the received vehicles 101. This allows the user to be resourceful with how much water is used and reduces wastage of water. This also means less mechanical issues as there are lesser mechanical components.

In an embodiment, the shipping containers 111a and 111b are not welded together. Instead, the shipping containers 111a and 111b are clamped together using clamps when the portable vehicle wash container 100 is delivered. Both of the shipping containers 111a and 111b can be separated anytime for shipping purposes. The waste receptacle 109 for receiving wastewater is installed along with the clamping of the shipping containers 111a and 111b. In an embodiment, the portable vehicle wash container 100 can be dropped off and picked up the same day or can be dropped off for a few days. A separate vehicle refills clean water into the clean fluid reservoir 103 and takes away wastewater from the waste fluid reservoir 104. In an embodiment, the clean fluid reservoir 103, the waste fluid reservoir 104, and the power generator 105 are positioned in the space 112. The portable vehicle wash container 100 ensures an eco-friendly car wash, which is transportable and can be left in location with minimal space, for example, shopping malls, country clubs, office spaces, apartments, etc.

The foregoing examples have been provided merely for the purpose of explanation and are in no way to be construed as limiting of the portable vehicle wash container 100, disclosed herein. While the portable vehicle wash container 100 has been described with reference to various embodiments, it is understood that the words, which have been used herein, are words of description and illustration, rather than words of limitation. Further, although the portable vehicle wash container 100 has been described herein with reference to particular means, materials, and embodiments, the portable vehicle wash container 100 is not intended to be limited to the particulars disclosed herein; rather, the portable vehicle wash container 100 extends to all functionally equivalent structures, methods and uses, such as are within the scope of the invention. Although there has been shown and described the preferred embodiment of the present invention, it will be readily apparent to those skilled in the art that modifications may be made thereto.

What is claimed is:

1. A portable vehicle wash container for enabling a user to wash a vehicle, the portable vehicle wash container comprising:
at least two ramps detachably attached to an entrance and an exit of a container for facilitating an entry and an exit of the vehicle;
a clean fluid reservoir comprising a pressure hose for supplying a fluid to wash the vehicle;
a waste fluid reservoir comprising a vacuum hose, the vacuum hose in fluid communication with a waste receptacle for transferring the waste fluid from the waste receptacle to the waste fluid reservoir, wherein the waste receptacle is positioned beneath the vehicle to receive waste fluid from washing the vehicle;
a power generator for powering the pressure hose and the vacuum hose; and
the container having a generally hollow cuboidal configuration comprising a space for receiving the vehicle, wherein the clean fluid reservoir, the waste fluid reservoir, and the power generator are positioned in the space, and wherein the user washes the vehicle in the space of the container using clean fluid from the pressure hose.

2. The portable vehicle wash container of claim 1, further comprising one or more portals hingedly attached to opposing ends of the container for controlling one of the entry and the exit of the vehicle.

3. The portable vehicle wash container of claim 1, wherein the container is a modified shipping container comprising at least two shipping containers positioned adjacent to each other, an adjacent sidewall of each of the at least two shipping containers removed for fixedly attaching the at least two shipping containers to form the modified shipping container.

4. The portable vehicle wash container of claim 1, wherein the vehicle is one of a car, a jeep, a minivan, and a pickup truck.

5. A portable vehicle wash container for enabling a user to wash a vehicle, the portable vehicle wash container comprising:
at least two ramps detachably attached to an entrance and an exit of a modified shipping container for facilitating an entry and an exit of the vehicle;
a clean fluid reservoir comprising a pressure hose for supplying a fluid to wash the vehicle;
a waste fluid reservoir comprising a vacuum hose, the vacuum hose in fluid communication with a waste receptacle for transferring the waste fluid from the waste receptacle to the waste fluid reservoir, wherein the waste receptacle is positioned beneath the vehicle to receive waste fluid from washing the vehicle;
a power generator for powering the pressure hose and the vacuum hose; and
the modified shipping container having a generally hollow cuboidal configuration comprising a space for receiving the vehicle, wherein the clean fluid reservoir, the waste fluid reservoir, and the power generator is positioned in the space, wherein the modified shipping container comprising at least two shipping containers is positioned adjacent to each other, an adjacent sidewall of each of the at least two shipping containers removed for fixedly attaching the at least two shipping containers to form the modified shipping container, wherein the clean fluid reservoir, the waste fluid reservoir, and the power generator are positioned in the space and wherein the user washes the vehicle in the space of the modified shipping container using clean fluid from the pressure hose.

6. The portable vehicle wash container of claim 5, further comprising one or more portals hingedly attached to opposing ends of the modified shipping container for controlling one of the entry and the exit of the vehicle.

7. The portable vehicle wash container of claim 5, wherein the vehicle is one of a car, a jeep, a minivan, and a pickup truck.
